(19) United States
(12) Patent Application Publication
(10) Pub. No.: US 2024/0078225 A1
(43) Pub. Date: Mar. 7, 2024

(54) TRANSACTION MANAGEMENT METHOD AND TRANSACTION MANAGEMENT APPARATUS

(71) Applicant: Hitachi, Ltd., Tokyo (JP)

(72) Inventor: Nao NISHIJIMA, Tokyo (JP)

(73) Assignee: Hitachi, Ltd., Tokyo (JP)

(21) Appl. No.: 18/179,416

(22) Filed: Mar. 7, 2023

(30) Foreign Application Priority Data
Sep. 7, 2022 (JP) 2022-142514

(51) Int. Cl. G06F 16/23

(52) U.S. Cl. CPC G06F 16/2379

(57) ABSTRACT

A transaction management apparatus, which is a queuing server configured to execute processing of holding a history of transactions between a WEB server (client) and a distributed ledger server in a blockchain system, processing of identifying a transaction updating a sane key based on the history and saving the transaction to a queue, and processing of transmitting the transaction after an elapse of a prescribed time period in which the same key is not updated in the same block.

### CROSS-REFERENCE TO RELATED APPLICATION

This application claims priority pursuant to Japanese patent application No. 2022-142514, filed on Sep. 7, 2022, the entire discourse of which is incorporated herein by reference.

### BACKGROUND OF THE INVENTION

### Technical Field

The present invention relates to a transaction management method and a transaction management apparatus.

### Related Art

A blockchain is one of the distributed ledger technologies. The blockchain is a series of blocks that bundles transactions, which are issued from corresponding nodes and on which a consensus is built, for each certain time period, and the blockchain is a kind of distributed database.

Blocks forming the above-described blockchain each include a time stamp and a hash value of a previous block. For this reason, it is considerably difficult to retroactively change an arbitrary single block on the blockchain. That is, it can be said that it is highly resistant to tampering.

The above-described blockchains are distributed respectively to multiple places on a distributed ledger network or distributed ledger nodes and are stored with the same contents. In other words, unlike a conventional system, the data held by the blockchains is never held and managed in a centralized manner.

Additionally, a smart contract makes it possible to automatically execute and manage a transaction appropriately and flexibly implement various functions. It is also possible to implement endorsement to certify the validity of a result of the execution of the transaction by the smart contract.

The smart contract is made for the latest status of data manipulation written in the transactions stored in the block so far. It is also possible to implement a state database that holds information corresponding to the latest status.

Incidentally, the transactions in the blockchain are issued simultaneously from multiple places. For this reason, when a value of the same key is updated, there is required a mechanism to guarantee the consistency of the data without losing the concurrency.

This mechanism is called multi version concurrency control (MVCC), and various countermeasures are implemented by a control technique that improves the availability of a database. The MVCC in a distribution system usually requests re-transmission processing along with detection of update of the same key. For this reason, the MVCC may cause the performance degradation. In a blockchain system that requires predetermined performance, it is necessary to implement an MVCC countermeasure to prevent the performance degradation as described above.

As the MVCC in the blockchain as described above, there has been proposed a technique described in https://blogs.oracle.com/blockchain/post/obptokenoptimization (NPTL1).

In addition to the above, there has been also proposed a data management system (ix Japanese Patent Application Publication No. 2021-184252) that implements improvement of the search feature and security of the tamper detection feature in status update processing of a specified target.

This technique is related to a data management system, including: a reception unit that receives a status update request in which a target is specified; and an execution unit that executes status update processing of updating a status of the target specified in the status update request, in which the status update processing includes transaction processing that is processing of updating first information and second information in an ACID (Atomicity Consistency Isolation, Durability) transactional manner, the first information is a first object group for the target, the first object group is one or more first objects, the first object is data that represents the status of the target, the second information is a second object group for the target, the second object group is one or more second objects, the transaction processing includes first processing of creating, updating, or deleting the first object corresponding to the specified target, and second processing of adding the second object including at least one of a content of the first processing and a summary of the first object to the second object group corresponding to the specified target, the status update request includes a first argument group that is one or more arguments used for the first processing, an argument group summary that is a summary of the first argument group, and an electronic signature on the argument group summary, and the execution unit executes first tamper-evidence processing of detecting whether the argument group summary is tampered with, by using the electronic signature, and second tamper-evidence processing of, when no tampering is detected in the first tamper-evidence processing, detecting whether the first argument group is tampered with, by using the argument group summary.

### SUMMARY OF THE INVENTION

A distributed ledger system for an enterprise usually requires predetermined performance, and the MVCC countermeasure is necessary in a case of a high load.

The technique described in NPTL1 provides an MVCC optimization function in the distributed ledger system. However, the technique is compatible with only a use case using the unspent transaction output (UXTO) format and is inadaptable to a common use case.

Therefore, an object of the present invention is to provide a technique that can reduce the performance degradation due to MVCC even in a common use case.

A transaction management method of the present disclosure to solve the above problem, by a queuing server, comprising: executing processing of holding a history of transactions between a client and a distributed ledger server in a blockchain system, processing of identifying a transaction updating a same key based on the history and saving the transaction to a queue, and processing of transmitting the transaction to the distributed ledger server after an elapse of a prescribed time period in which the same key is not updated in the same block.

A transaction management apparatus of the present disclosure, which is a queuing server configured to execute processing of holding a history of transactions between a client and a peer in a blockchain system, processing of identifying a transaction updating a sane key based on the history and saving the transaction to a queue, and processing of transmitting the transaction after an elapse of a prescribed time period in which the same key is not updated in the same block.

According to the present invention, it is possible to reduce the performance degradation due to MVCC even in a common use case.

### BRIEF DESCRIPTION OF THE DRAWINGS

FIG. 1 is a diagram illustrating a network configuration example including a queuing server in a present embodiment.

FIG. 2 is a diagram illustrating a configuration example of a distributed ledger system in the present embodiment.

FIG. 3 is a diagram illustrating a hardware configuration example of a queuing server (a transaction management apparatus) in the present embodiment.

FIG. 4 is a diagram illustrating a flow example of a transaction management method in the present embodiment.

FIG. 5 is a diagram illustrating a table example of a transaction history in the present embodiment.

FIG. 6 is a diagram illustrating a table example of a transaction queue in the present embodiment.

FIG. 7 is a diagram illustrating a network configuration example including a queuing server in another embodiment.

### DETAILED DESCRIPTION OF THE INVENTION

### Example 1

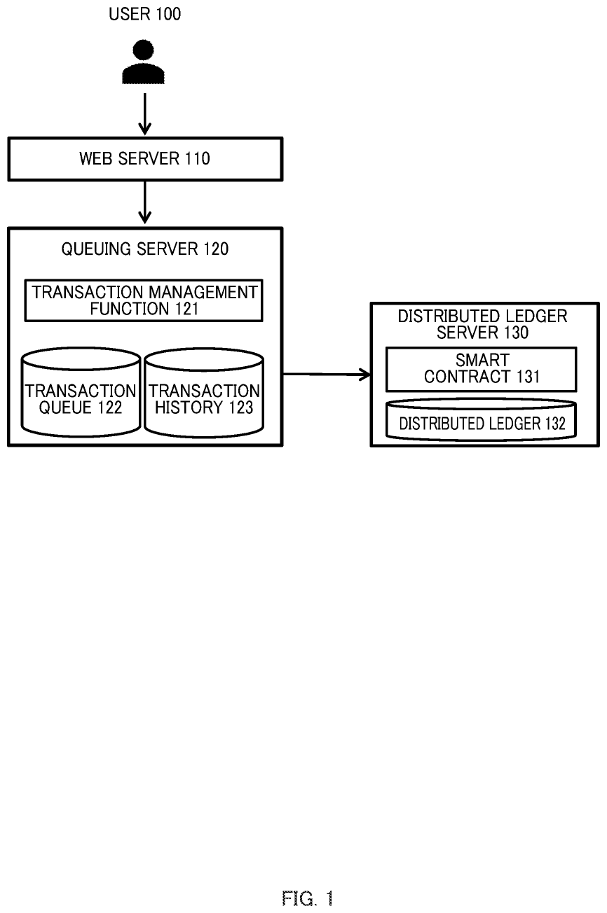

An embodiment of the present invention is described below in detail with reference to the drawings. FIG. 1 is a network configuration diagram including a queuing server 120 as a transaction management apparatus of the present embodiment (hereinafter, a queuing server 120).

The queuing server 120 illustrated in FIG. 1 is a server device that can reduce the performance degradation due to MVCC even in a common use case.

As illustrated in FIG. 1, the queuing server 120 of the present embodiment is communicably coupled with a WEB server 110 and a distributed ledger server 130 through an appropriate network 1 such as the Internet and a local area network (LAN). Those are devices forming a so-called blockchain system.

Note that, the above-described WEB server 110 is a client who provides a predetermined service to a user through an appropriate user interface (UI) and application and issues a transaction associated therewith.

The queuing server 120 of the present embodiment includes a transaction management function 121 and databases, which are a transaction queue 122 and a transaction history 123.

This queuing server 120 receives the transaction issued by the WEB server 110 in response to a terminal operation by a user 100. The transaction may be in any format as long as a Key is unique and may be in a common Key-Value format.

Additionally, the queuing server 120 saves this transaction to the transaction queue 122 by the transaction management function 121 or transmits the transaction to the distributed ledger server 130.

When the transaction received from the WEB server 110 is not directly transmitted to the distributed ledger server 130, the queuing server 120 saves the transaction to the transaction queue 122. Additionally, the transaction history 123 is a history of the transactions received by the queuing server 120.

On the other hand, the distributed ledger server 130 receives the transaction from the queuing server 120 and executes a smart contract 131 and then saves the result to a distributed ledger 132. This is a distributed ledger node in a so-called blockchain system.

Note that, the communication between the above-described devices is encrypted by using an appropriate protocol such as hypertext transfer protocol secure (https).

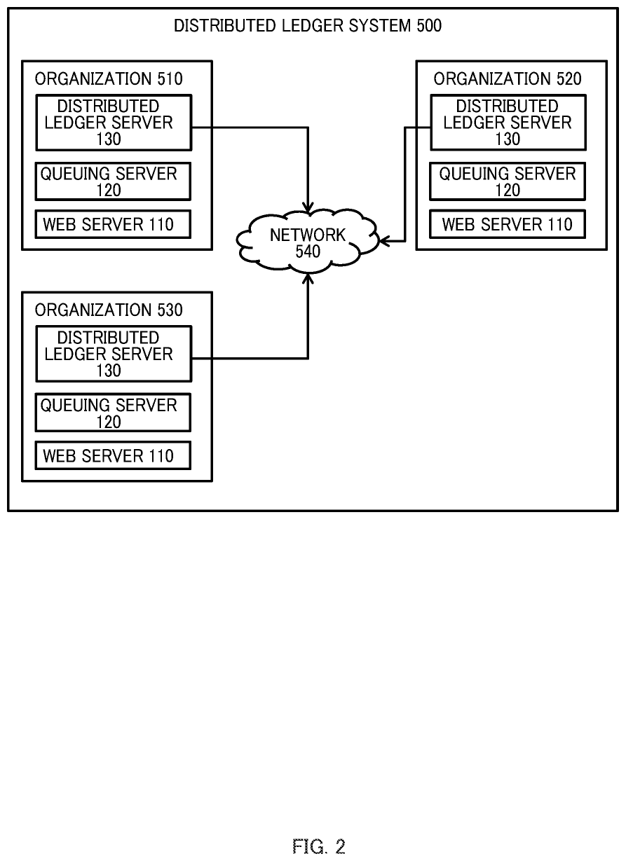

FIG. 2 is a diagram illustrating a configuration example of a distributed ledger system 500 in the present embodiment. The distributed ledger system 500 of the present embodiment includes equipment that is each operated by corresponding one or more organizations.

In a case exemplified in FIG. 2, the distributed ledger system 500 includes equipment of three organizations 510, 520, and 530. Each organization or, for example, the organization 510 operates the distributed ledger server 130, the queuing server 120, and the WEB server 110.

In a case of this example, the distributed ledger system 500 includes the distributed ledger server 130 of one or more organizations. Additionally, the distributed ledger servers 130 can communicate with each other through an appropriate network 540 such as the Internet.

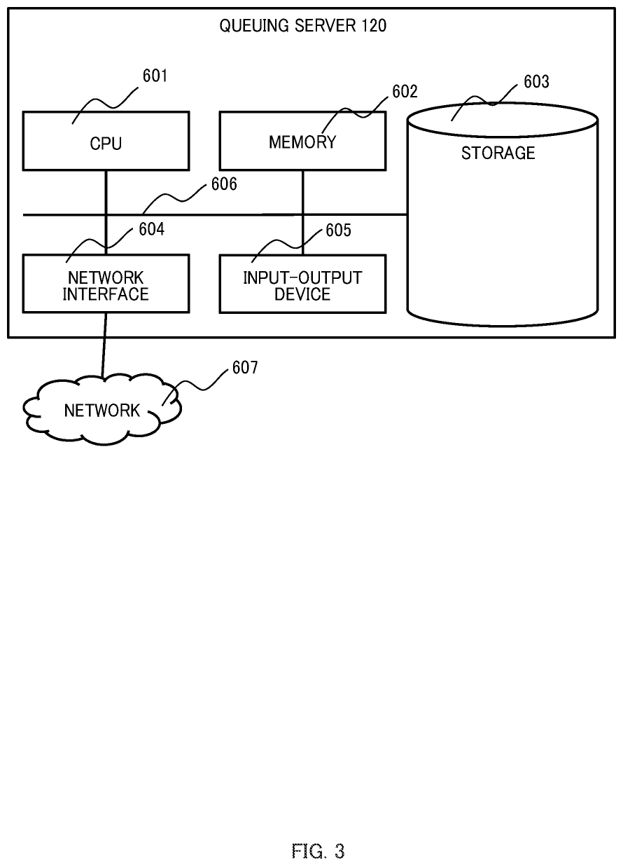

FIG. 3 is a diagram illustrating a hardware configuration example of the queuing server 120 in the present embodiment. The configuration of the queuing server 120 of the present embodiment may be implemented by multiple physical servers or an arbitrary number of methods or may be implemented by a single server.

The queuing server 120 includes a central processing unit (CPU) 601, a memory 602, a storage 603, a network interface 604, and an input-output device 605. Note that, the constituents are coupled to each other through an interface 606 such as an internal bus.

Among the above, the CPU 601 implements various functions by executing a program recorded in the memory 602.

Additionally, the memory 602 is a volatile storage element such as a random access memory (RAM) that holds the program to be executed by the CPU 601 and temporarily holds various types of information when the program is executed.

Moreover, the storage 603 is a non-volatile storage element such as a hard disk drive (HDD) and a solid state drive (SSD) that stores various data and programs.

In addition to the program for implementing a function required for the transaction management apparatus of the present embodiment, the storage 603 at least stores the transaction queue 122 and the transaction history 123. Those databases are described later in detail. Additionally, the program implements the transaction management function 121 by being executed by the CPU 601.

Furthermore, the network interface 604 is a communication device that couples the queuing server 120 to a network 607 (the network 540 in FIG. 2).

Additionally, the input-output device 605 is a keyboard, a mouse, a display, and the like operated by a person in charge of the organization or an interface that transmits and receives input-output data to and from the above devices.

Note that, the hardware configuration illustrated in FIG. 3 regarding the queuing server 120 is similarly applied to the WEB server 110 and the distributed ledger server 130. Note that, the distributed ledger server 130 holds the smart contract 131 and the distributed ledger 132 in a storage thereof.

Actual procedure of a transaction management method in the present embodiment is described below based on the drawing. Various operations corresponding to the transaction management method described below are implemented by the program read to the memory and the like and executed by the queuing server 120 as the transaction management apparatus. The program includes a code for performing various operations described below.

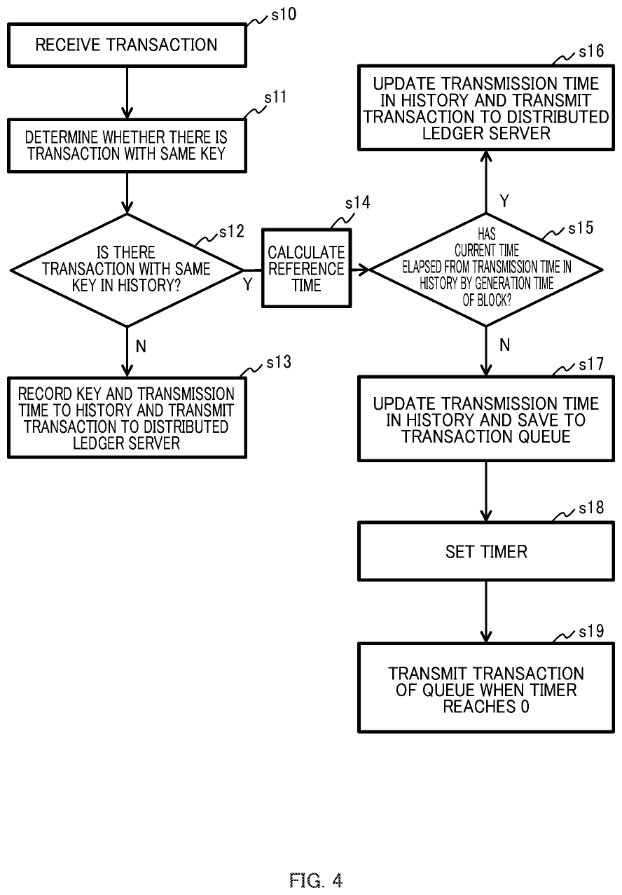

FIG. 4 is a diagram illustrating a flow example of the transaction management method in the present embodiment. In this case, the queuing server 120 receives the transaction from the WEB server 110 (s10). In this process, the WEB server 110 does not issue the transaction by performing specific processing based on the transaction management method of the present invention but issues the transaction as a normal distributed ledger node.

Subsequently, the queuing server 120 determines whether there is already stored in the transaction history 123 an already-existing transaction with a key same as that of the transaction received in s10 (s11).

If the transaction with the same key is not identified in the transaction history 123 as a result of the above-described determination (s12: N), the queuing server 120 records the key of the transaction received in s10 and transmission time (current time) to the transaction history 123 and transmits the transaction to the distributed ledger server 130 (s13).

On the other hand, if the transaction with the same key is identified in the transaction history 123 as a result of the above-described determination (s12: Y), the queuing server 120 calculates reference time by adding generation time of a block that is set in advance to the transmission time of the transaction that is identified in the transaction history 123 (s14).

Additionally, the queuing server 120 compares the reference time obtained in s14 described above with the current time and determines whether the current time has elapsed from the reference time (s15).

If the current time has elapsed from the reference time described above as a result of the above-described determination (s15: Y), the queuing server 120 updates the transmission time held in relation to the above-described transaction in the transaction history 123 to the current time (new transmission time) and transmits the transaction to the distributed ledger server 130 (s16).

On the other hand, if the current time has not elapsed from the above-described reference time as a result of the above-described determination (s15: N), the queuing server 120 updates the transmission time held in relation to the above-described transaction in the transaction history 123 to the time obtained by adding the block generation time to the transmission time (s17). Additionally, the queuing server 120 saves the transaction to the transaction queue 122 and sets a predetermined timer to the time updated in s17 (s18).

Once the above-described timer reaches 0, the queuing server 120 transmits the transaction saved in the above-described transaction queue 122 to the distributed ledger server 130 (s19).

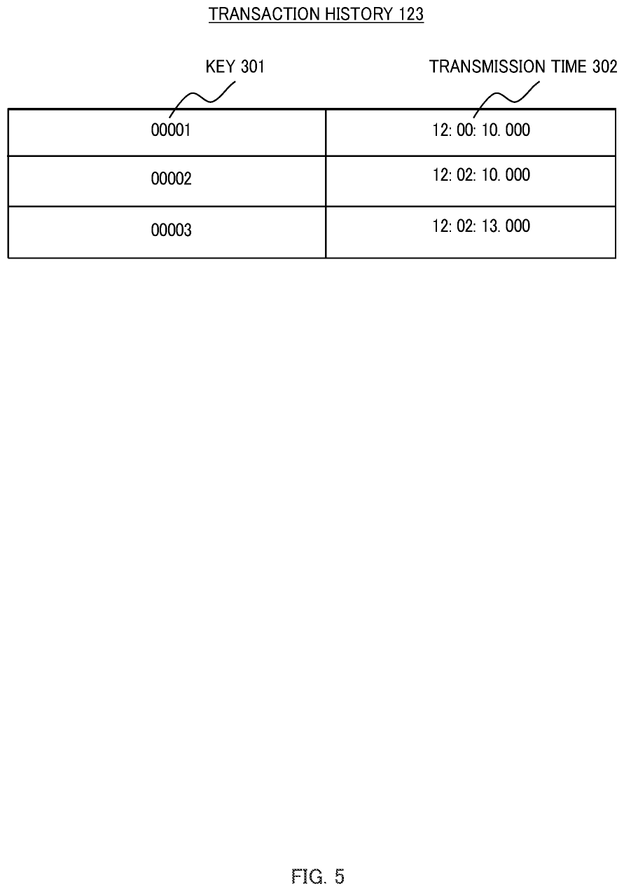

A specific example of the above-described transaction history 123 is illustrated in FIG. 5. In a table configuration example of the transaction history 123 in the present embodiment, key 301 is a key of the transaction received from the WEB server 110, and transmission time 302 is the transmission time of the transaction.

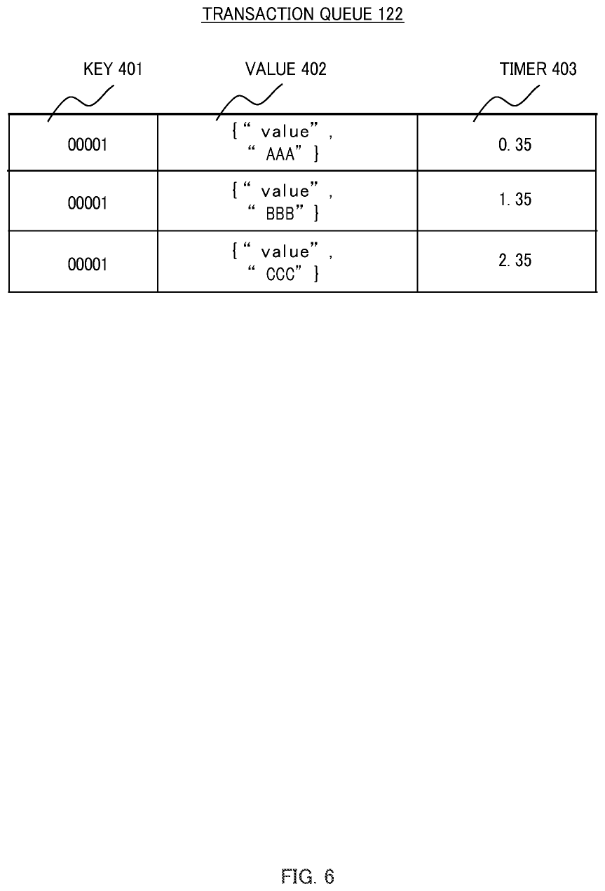

Additionally FIG. 6 illustrates a table configuration example of the transaction queue 122 of the present embodiment. In the transaction queue 122 of the present embodiment, key 401 is a key in a case where there is the transaction with the same key in the transaction history 123 in the step s12 of the flowchart in FIG. 4. Moreover, value 402 is data of the transaction with the key. Furthermore, timer 403 is the timer set in the step s18 of the flowchart in FIG. 4.

### Example 2

The present example describes another embodiment of the queuing server 120 in the above-described Example 1 and describes a configuration including a monitoring function 124. As a specific configuration, the monitoring function 124 is assembled in the queuing server 120 in FIG. 1.

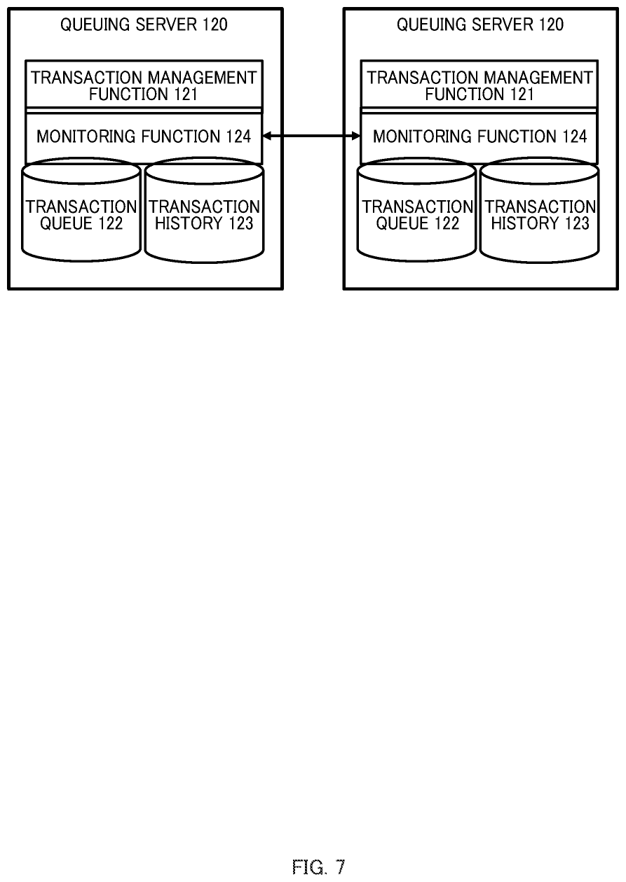

FIG. 7 is a diagram illustrating a configuration example of the queuing server 120 in the present example. In this case, the monitoring function 124 monitors the generation time of the block by monitoring the distributed ledger server 130 of the own organization. Additionally, the monitoring function 124 communicates with the monitoring function 124 of another organization and collects the block generation time thereof.

The monitoring function 124 in each queuing server 120 monitors the block generation time in the distributed ledger 132 of each distributed ledger server 130 and holds this status. The length of the block generation time is likely to reflect the magnitude of a processing load in the distributed ledger server 130. Therefore, it is possible to presume that, when the block generation time is longer than the reference or that of another distributed ledger server 130, the processing load in the distributed ledger server 130 is increased.

Accordingly, in the steps s13, s16, and s19 in the flowchart of FIG. 4, the queuing server 120 does not transmit the transaction to the distributed ledger server 130 of the own organization unconditionally but transmits the transaction to the distributed ledger server 130 of an organization with short block generation time (identified from the monitoring result by the monitoring function 124). The above-described control makes it possible to improve the performance of the distributed ledger system.

The best mode and the like to implement the present invention are specifically described above; however, the present invention is not limited thereto and can be changed in various ways without departing from the gist.

According to the above-described embodiments, it is possible to reduce the performance degradation due to MVCC even in a common use case.

At least the followings are clarified by the descriptions in the present specification. That is, in the transaction management method of the present embodiment, when transmitting the transaction, the queuing server may transmit the transaction to a distributed ledger server with a lower load among distributed ledger servers based on a load monitoring result by the distributed ledger server.

According to the above, it is possible to transmit a transaction to a distributed ledger server in a state with a smaller processing load based on the processing load state of each distributed ledger server and to improve the performance of the distributed ledger system.

Additionally, in the transaction management apparatus of the present embodiment, when transmitting the transaction, the queuing server may transmit the transaction to a distributed ledger server with a lower bad among distributed ledger servers based on a bad monitoring result by the distributed ledger server.
100 user
110 WEB server
120 queuing server (transaction management apparatus)
122 transaction queue
123 transaction history
130 distributed ledger server
131 smart contract
132 distributed ledger
510 to 530 organization
540, 607 network
601 CPU
602 memory
603 storage
604 network interface
605 input-output device

1. A transaction management method by a queuing server, comprising:
executing processing of holding a history of transactions between a client and a distributed ledger server in a blockchain system, processing of identifying a transaction updating a same key based on the history and saving the transaction to a queue, and processing of transmitting the transaction to the distributed ledger server after an elapse of a prescribed time period in which the same key is not updated in the same block.

2. The transaction management method according to claim 1, wherein
when transmitting the transaction, the queuing server transmits the transaction to a distributed ledger server with a lower load among distributed ledger servers based on a load monitoring result by the distributed ledger server.

3. A transaction management apparatus, which is a queuing server configured to execute processing of holding a history of transactions between a client and a distributed ledger server in a blockchain system, processing of identifying a transaction updating a same key based on the history and saving the transaction to a queue, and processing of transmitting the transaction after an elapse of a prescribed time period in which the same key is not updated in the same block.

4. The transaction management apparatus according to claim 3, wherein
when transmitting the transaction, the queuing server transmits the transaction to a distributed ledger server with a lower load among distributed ledger servers based on a load monitoring result by the distributed ledger server.
